(19) United States
(12) Patent Application Publication
(10) Pub. No.: US 2025/0212099 A1
(43) Pub. Date: Jun. 26, 2025

(54) DISCOVERING COMMON EDGE APPLICATION SERVER FOR MULTI-USER SESSION IN EDGE DATA NETWORK

(71) Applicant: Samsung Electronics Co., Ltd., Gyeonggi-do (KR)

(72) Inventors: Basavaraj Jayawant PATTAN, Bangalore (IN); Sapan Pramodkumar SHAH, Bangalore (IN); Narendranath Durga TANGUDU, Bangalore (IN)

(21) Appl. No.: 18/851,964

(22) PCT Filed: Mar. 29, 2023
(86) PCT No.: PCT/KR2023/004216

§ 371 Date: Sep. 27, 2024

(30) Foreign Application Priority Data
Mar. 29, 2022 (IN) 202241018532
May 20, 2022 (IN) 202241029257
Mar. 14, 2023 (IN) 202241018532

(51) Int. Cl. H04W 48/16; H04L 5/00; H04W 48/20

(52) U.S. Cl. CPC H04W 48/16; H04L 5/0053; H04W 48/20

(57) ABSTRACT

The disclosure relates to a 5G or 6G communication system for supporting a higher data transmission rate. Embodiments herein provide a first Edge Enabler Client (EEC) and a method for discovering a common Edge Application Server (EAS) for a multi-user or a multi-Application Client (AC) session in a wireless communication network. The method further includes detecting, by the first EEC, a trigger for an EAS discovery. The method further includes transmitting, by the first EEC, an EAS discovery request message with a grouping information to an Edge Enabler Server (EES). The method further includes receiving, by the first EEC, an EAS discovery response message with at least one of a plurality of EAS or an already selected common EAS based on the grouping information. The method further includes determining, by the first EEC, a common EAS for establishing the multi-user session or the multi AC session in between the first EEC and at least one second EEC.

### TECHNICAL FIELD

The disclosure relates to edge computing, and more specifically to an Edge Enabler Client (EEC) and a method of discovering a common Edge Application Server (EAS) for a multi-user or a multi-Application Client (AC) session.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Generally, an edge computing system is a distributed computing paradigm that brings computations and data storage closer to a geographical location. An Edge Enabler Client (EEC) connects with an Edge Application Server (EAS) through an Edge Enabler Server (EES) to get a service. In some scenarios, plurality of EES and plurality of EAS that are offering the same service are deployed within an Edge Data Network (EDN) located at different locations.

During a real-time communication in a multi-user session, plurality of EEC in the multi user session selects at least one EAS from the plurality of the EAS for the multi-user session, where the EAS selected by one EEC might be different from the EAS selected by other EEC. Thus the selected multiple EAS needs to synchronize with each other in order to maintain the multi-user session. However maintaining the multi-user session that is connected through multiple EAS, increases latency and difficulty due to inter-EAS synchronization.

Thus, it is desired to address the above mentioned disadvantages or other shortcomings or at least provide a useful alternative to avoid inter-EAS synchronization and reduce latency in communication.

### DISCLOSURE OF INVENTION

### Solution to Problem

A principal aspect of the embodiments herein is to provide an Edge Enabler Client (EEC) and a method of discovering a common Edge Application Server (EAS) for a multi-user or a multi-Application Client (AC) session to keep the latency for all the ACs in the session approximately the same.

Another aspect of the embodiments herein is to determine a common EAS for establishing the multi-user session or the multi AC session in between a first EEC (100) and at least one second EEC which avoids the need for inter-EAS synchronization.

Another aspect of the embodiments herein is to determine at least one second EES to inform the selected common EAS for the multi-user or the multi AC session.

Another aspect of the embodiments herein is to determine whether the common EAS is already selected for the multi-user or the multi AC session based on a grouping information.

Accordingly the embodiment herein is to provide a method of discovering a common Edge Application Server (EAS) for a multi-user or a multi-Application Client (AC) session in a wireless communication network. The method further includes detecting, by a first Edge Enabler Client (EEC), a trigger for an EAS discovery. The method further includes transmitting, by the first EEC, an EAS discovery request message to an Edge Enabler Server (EES), where the EAS discovery request message comprises a grouping information for the multi-user session or the multi AC session. The method further includes receiving, by the first EEC, an EAS discovery response message from the EES, wherein the EAS discovery response message comprises at least one of a plurality of EAS or an already selected common EAS based on the grouping information. The method further includes determining, by the first EEC, a common EAS for establishing the multi-user session or the multi AC session in between the first EEC and at least one second EEC based on at least one of the EAS discovery response message and grouping information.

In an embodiment, the method includes transmitting, by the first EEC, a selected EAS announcement request message to the EES, wherein the selected EAS announcement request message comprises the selected common EAS and the grouping information to the EES. The method further includes receiving, by the first EEC, a selected EAS announcement response message from the EES, wherein the selected EAS announcement response message comprises the acknowledgement.

In an embodiment, the grouping information comprises: a grouping requirement information element (IE) indicating grouping is required for the application; a multi-user session IE indicating application requires multi-user session; a multi-AC session IE indicating multiple ACs is part of the session; a group ID IE indicating the ID for grouping of users of same AC or grouping of ACs; and a List of ACIDs IE indicating one or more ACIDs need to be served by the common EAS, to be part of the multi-user session.

In an embodiment, the selected EAS announcement request message comprises the AC ID, an EAS ID, an EAS endpoint, and a User Equipment ID.

In an embodiment, the method includes receiving, by the first EES, the EAS discovery request message from the first EEC, wherein the EAS discovery request message comprises the grouping information for the multi-user or the multi AC session. The method further includes transmitting, by the first EES, the EAS discovery response message to the first EEC, wherein the EAS discovery response message comprises the plurality of EAS based on the grouping information. The method further includes receiving, by the first EES, the selected EAS announcement request message from the first EEC, wherein the selected EAS announcement request message comprises the selected common EAS, wherein the first EEC selects the common EAS from the plurality of EAS for the multi-user or the multi AC session in between the first EEC and at least one second EEC. The method further includes determining, by the first EES, at least one second EES to inform the selected common EAS for the multi-user or the multi AC session.

In an embodiment, the method includes transmitting, by the first EES, the ID of the selected common EAS to the ECS, wherein the ECS (301) determines the at least one second EES that serve the same ID of the selected common EAS. The method further includes receiving, by the first EES, the Identifier of the at least one second EES that have the same ID of the selected common EAS from the ECS. The method further includes transmitting, by the first EES, a declare common EAS request message to the at least one second EES; wherein the declare common EAS request message comprises the selected common EAS along with the grouping information. The method further includes receiving, by the first EES, a declare common EAS response message from the at least one second EES; wherein the declare common EAS response message comprises the acknowledgement.

In an embodiment, the method includes receiving, by the first EES, the EAS discovery request message from the first EEC. The method further includes determining, by the first EES, whether the common EAS is already selected for the multi-user or the multi AC session based on the grouping information. The method further includes transmitting, by the EES, the already selected common EAS to the first EEC to initiate the multi-user or the multi AC session when the common EAS is already selected for the multi-user or the multi AC session based on the grouping information. The method further includes selecting, by the EES, the plurality of EAS based on the grouping information when the common EAS is not already selected for the multi-user or the multi AC session based on the grouping information. The method further includes sending the plurality of EAS to the first EEC.

Accordingly the embodiment herein is to provide a first EEC for discovering a common Edge Application Server (EAS) for a multi-user or a multi-Application Client (AC) session in a wireless communication network. The first EEC comprises a memory; a processor; and EAS discoverer, coupled to the memory and the processor. The EAS discoverer is configured to detect a trigger for an EAS discovery. The EAS discoverer is further configured to transmit an EAS discovery request message to an Edge Enabler Server (EES), wherein the EAS discovery request message comprises a grouping information for the multi-user session or the multi AC session. The EAS discoverer is further configured to receive an EAS discovery response message from the EES, wherein the EAS discovery response message comprises at least one of a plurality of EAS or an already selected common EAS based on the grouping information. The EAS discoverer is further configured to determine a common EAS for establishing the multi-user session or the multi AC session in between the first EEC and at least one second EEC based on at least one of the EAS discovery response message and grouping information.

Accordingly the embodiment herein is to provide the first EES for discovering a common Edge Application Server (EAS) for a multi-user or a multi-Application Client (AC) session in a wireless communication network. The first EES comprises a memory; a processor; and the EAS announcer, coupled to the memory and the processor. The EAS announcer is configured to receive an EAS discovery request message from a first Edge Enabler Client (EEC), wherein the EAS discovery request message comprises a grouping information for the multi-user or the multi AC session. The EAS announcer is further configured to transmit an EAS discovery response message to the first EEC, wherein the EAS discovery response message comprises a plurality of EAS based on the grouping information. The EAS announcer is further configured to receive a selected EAS announcement request message from the first EEC, wherein the selected EAS announcement request message comprises a selected common EAS, wherein the first EEC selects the common EAS from the plurality of EAS for the multi-user or the multi AC session in between the first EEC and at least one second EEC. The EAS announcer is further configured to determine at least one second EES to inform the selected common EAS for the multi-user or the multi AC session.

These and other aspects of the embodiments herein will be better appreciated and understood when considered in conjunction with the following description and the accompanying drawings. It should be understood, however, that the following de-scriptions, while indicating preferred embodiments and numerous specific details thereof, are given by way of illustration and not of limitation. Many changes and modifications may be made within the scope of the embodiments herein, and the embodiments herein include all such modifications.

### BRIEF DESCRIPTION OF DRAWINGS

The disclosure is illustrated in the accompanying drawings, throughout which like reference letters indicate corresponding parts in the various figures. The embodiments herein will be better understood from the following description with reference to the drawings, in which:

FIG. 1 is sequence diagram illustrating an Edge Application Server (EAS) discovery procedure, according to the prior arts;

FIG. 2 is a block diagram of a system for discovering a common EAS, according to the embodiments as disclosed herein;

FIG. 3a is a flow chart illustrating a method of discovering the common EAS by an Edge Enabler Client (EEC), according to the embodiments as disclosed herein;

FIG. 3b is a flow chart illustrating a method of discovering the common EAS by an Edge Enabler Server (EES), according to the embodiments as disclosed herein;

FIG. 4 is a sequence diagram illustrating the EEC based EAS Discovery procedure for common EAS selection, according to the embodiments as disclosed herein;

FIG. 5 is a sequence diagram illustrating the EEC based EAS Discovery procedure and involvement of the EAS, according to the embodiments as disclosed herein;

FIG. 6 is a sequence diagram illustrating the discovery of the common EAS when plurality of EEC(s) are connected to same EES, according to the embodiments as disclosed herein; and

FIG. 7 is a sequence diagram illustrating the discovery of the common EAS when plurality of EEC(s) are connected to different EES, according to the embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. De-scriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

An edge computing system is a distributed computing paradigm that brings computations and data storages closer to a geographical location where the computations and the data storages are needed, to improve response times and save bandwidth. With a 5th Generation (5G), it is expected to have data transmission speed increased by multiple times compare to previous generation networks. In order to reduce the latency, edge computing is essential which brings the computing resources near to the end users. In Rel-17, 3GPP has defined Edge Enabler Layer (EEL) in TS 23.558. The EEL exposes APIs to support capabilities like service provisioning, registration, application server discovery, capability exposure to Access Stratum (AS) and support for service continuity. The Application Clients (ACs) in the User Equipment (UE) are able to locate and connect with the most suitable Edge Application Server (EAS) available in the Edge Data Network (EDN), using the capabilities provided by the EEL.

According to the conventional methods it is possible that within the EDN, several EESs and several EASs offering the same service are deployed, possibly located at different locations. And specification enables the discovery of EAS by one EEC which is independent of the discovery of EAS by other UEs or ACs which may belong to the same User or another User. However, for certain use cases involving real-time communication in a multi-user session, both between AC and EAS and between different ACs via the EAS, it may be necessary or beneficial to use services from a single common EAS to meet the strict latency requirements, to avoid the need for inter-EAS synchronization or for any other reasons. The use cases may include, for example, a team of robots coordinating together on a manufacturing floor, a team of surgeons using VR headsets and robotic surgery equipment to operate together on a patient, multiplayer gaming service, or a group of trucks using V2X for platooning.

According to the conventional methods, the EEC of one user may select EAS which is different from the EAS selected by another user—although both users are part of the same communication session. If different EASs are selected for the users then different EASs need to synchronize with each other in order to maintain the communication session.

Dependent on the use case, the EEL may apply different additional criteria to determine this common EAS. E.g., it could be desirable to determine the EAS so that the latency for all the ACs in the session is approximately the same or that the latency for a specific AC is minimized.

For certain use cases involving real-time communication in a multi-user session, both between AC and EAS and between different ACs via the EAS, it may be necessary or beneficial to use services from a single common EAS to meet the strict latency requirements, to avoid the need for inter-EAS synchronization or for any other reasons. The use cases may include, for example, a team of robots coordinating together on a manufacturing floor, a team of surgeons using VR headsets and robotic surgery equipment to operate together on a patient, or a group of trucks using V2X for platooning.

According to the conventional methods, the EEC of one user may select an EAS which is different from the EAS selected by another user—although both users are part of the same communication session. If different EASs are selected for the users then different EASs need to synchronize with each other in order to maintain the communication session. Dependent on the use case, the EEL may apply different additional criteria to determine this common EAS. E.g., it could be desirable to determine the EAS so that the latency for all the ACs in the session is approximately the same or that the latency for a specific AC is minimized.

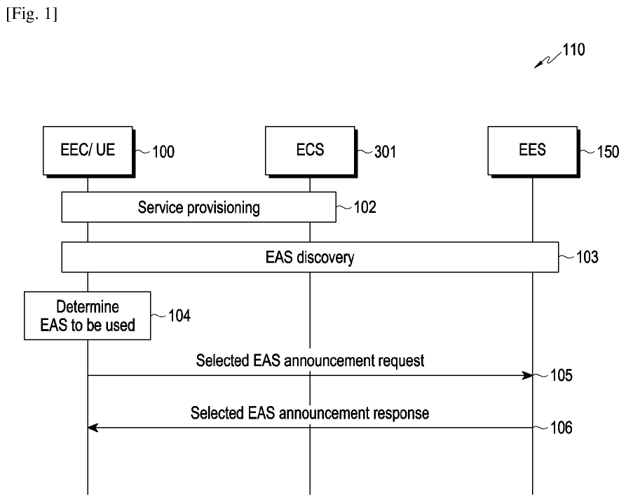

FIG. 1 is sequence diagram illustrating an Edge Application Server (EAS) discovery procedure, according to the prior arts.

At step 102, the EEC performs the start-up procedures for initial service provisioning with the help of ECS.

At step 103, the EEC performs the EAS discovery and returns with one or more EASes.

At step 104, when multiple EASs are discovered for a specific AC, the EEC may select one or more EASs to enable AC communication with one of the selected EASs i.e. the EEC (or AC and EEC) selects the initial EAS from the discovered EAS candidates.

At step 105, the EEC (100) sends a Selected EAS announcement to the EES (150).

At step 106, the EES sends a selected EAS announcement response to the EEC (100).

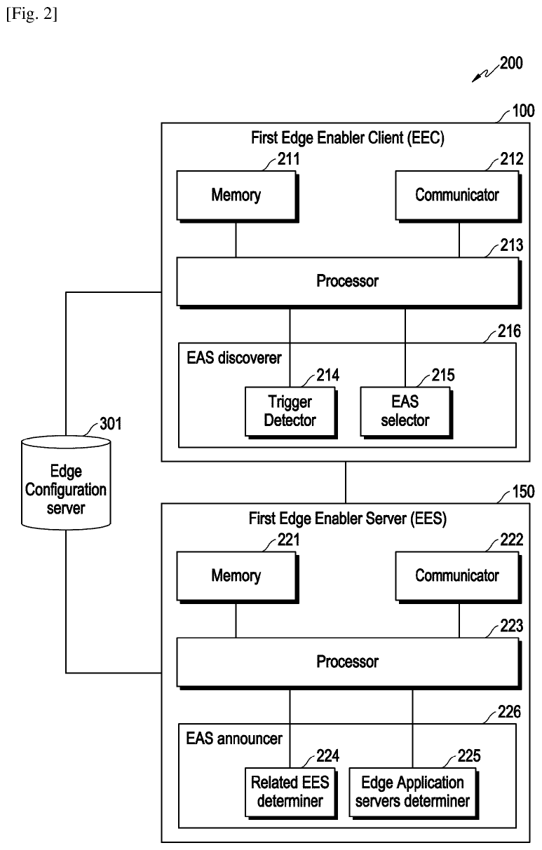

Referring now to the drawings and more particularly to FIGS. 2 through 7, where similar reference characters denote corresponding features consistently throughout the figures, there are shown preferred embodiments.

FIG. 2 is a block diagram of a system (200) for discovering a common EAS, according to the embodiments as disclosed herein.

FIG. 2 illustrates a block diagram of the system (200) for discovering a common EAS. The system includes a First Edge Enabler Client (EEC) (100), a First Edge Enabler Serve (EES) (150) and an Edge Configuration server (301).

The EEC (100) includes a memory (211), a communicator (212), a processor (213) and an EAS discoverer (216). The EAS discoverer (216) includes a trigger detector (214) and a EAS selector (215).

The EEC (100) for discovering the common EAS, according to an embodiment as disclosed herein. Examples of the EEC (100) include, but are not limited to a smartphone, a tablet computer, a Personal Digital Assistance (PDA), an Internet of Things (IoT) device, an AR device, a VR device, a wearable device, etc.

In an embodiment, the memory (211) stores a normal vector associated with a point cloud, a spatial feature associated with the point cloud, a similarity score of each vertex associated with the point cloud, an attention score, a global feature vector, a Model View and Projection Matrix (MVP), a plurality of image frames, and information associated with the point cloud. The memory (211) stores instructions to be executed by the processor (213). The memory (211) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (211) may, in some examples, be considered a non-transitory storage medium. The term “non-transitory” may indicate that the storage medium is not embodied in a carrier wave or a propagated signal. However, the term “non-transitory” should not be interpreted that the memory (211) is non-movable. In some examples, the memory (211) can be configured to store larger amounts of information than the memory. In certain examples, a non-transitory storage medium may store data that can, over time, change (e.g., in Random Access Memory (RAM) or cache). The memory (211) can be an internal storage unit or it can be an external storage unit of the EEC (100), a cloud storage, or any other type of external storage.

The processor (213) communicates with the memory (211), the processor (213) is configured to execute instructions stored in the memory (211) and to perform various processes. The processor (213) may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (212) is configured for communicating internally between internal hardware components and with external devices (e.g. eNodeB, gNodeB, server, etc.) via one or more networks (e.g. Radio technology). The communicator (212) includes an electronic circuit specific to a standard that enables wired or wireless communication.

The EAS discoverer (216) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

The Trigger Detector (214) detects a trigger for an EAS discovery. The EAS selector (215) transmits an EAS discovery request message to an Edge Enabler Server (EES), wherein the EAS discovery request message comprises a grouping information for the multi-user session or the multi AC session and receives an EAS discovery response message from the EES, wherein the EAS discovery response message comprises at least one of a plurality of EAS or an already selected common EAS based on the grouping information. The Trigger Detector (214) determine a common EAS for establishing the multi-user session or the multi AC session in between the first EEC (100) and at least one second EEC based on at least one of the EAS discovery response message and grouping information.

The EAS discoverer (216) is configured to transmit a selected EAS announcement request message to the EES, wherein the selected EAS announcement request message comprises the selected common EAS and the grouping information to the EES. The EAS discoverer (216) is further configured to receive a selected EAS announcement response message from the EES, wherein the selected EAS announcement response message comprises the acknowledgement.

In an embodiment, the grouping information includes a grouping requirement information element (IE) indicating grouping is required for the application; a multi-user session IE indicating application requires multi-user session; a multi-AC session IE indicating multiple ACs is part of the session; a group ID IE indicating the ID for grouping of users of same AC or grouping of ACs; and a List of ACIDs IE indicating one or more ACIDs need to be served by the common EAS, to be part of the multi-user session.

In an embodiment, the selected EAS announcement request message comprises the AC ID, an EAS ID, an EAS endpoint, and a User Equipment ID.

The EES (150) includes a memory (221), a communicator (222), a processor (223) and an EAS announcer (226). The EAS announcer (226) includes a related EES determiner (224) and an Edge Application servers determiner (225).

In an embodiment, the memory (221) stores a normal vector associated with a point cloud, a spatial feature associated with the point cloud, a similarity score of each vertex associated with the point cloud, an attention score, a global feature vector, a Model View and Projection Matrix (MVP), a plurality of image frames, and information associated with the point cloud. The memory (221) stores instructions to be executed by the processor (223). The memory (221) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (221) may, in some examples, be considered a non-transitory storage medium. The term “non-transitory” may indicate that the storage medium is not embodied in a carrier wave or a propagated signal. However, the term “non-transitory” should not be interpreted that the memory (221) is non-movable. In some examples, the memory (221) can be configured to store larger amounts of information than the memory. In certain examples, a non-transitory storage medium may store data that can, over time, change (e.g., in Random Access Memory (RAM) or cache). The memory (221) can be an internal storage unit or it can be an external storage unit of the EES (150), a cloud storage, or any other type of external storage.

The processor (223) communicates with the memory (221), the processor (223) is configured to execute instructions stored in the memory (221) and to perform various processes. The processor (223) may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (222) is configured for communicating internally between internal hardware components and with external devices (e.g. eNodeB, gNodeB, server, etc.) via one or more networks (e.g. Radio technology). The communicator (222) includes an electronic circuit specific to a standard that enables wired or wireless communication.

The EAS announcer (226) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

The Edge Application servers determiner (225) receive a EAS discovery request message from a first Edge Enabler Client (EEC), wherein the EAS discovery request message comprises a grouping information for the multi-user or the multi AC session and transmit a EAS discovery response message to the first EEC (100), wherein the EAS discovery response message comprises a plurality of EAS based on the grouping information.

The related EES determiner (224) receives a selected EAS announcement request message from the first EEC (100), wherein the selected EAS announcement request message comprises a selected common EAS, wherein the first EEC (100) selects the common EAS from the plurality of EAS for the multi-user or the multi AC session in between the first EEC (100) and at least one second EEC. The related EES determiner (224) determine at least one second EES to inform the selected common EAS for the multi-user or the multi AC session.

The EAS announcer (226) is configured to transmit an Identifier (ID) of the selected common EAS to the Edge Configuration Server (ECS), wherein the ECS (301) determines the at least one second EES that serve the same ID of the selected common EAS. The EAS announcer (226) is further configured to receive an Identifier of the at least one second EES that have the same ID of the selected common EAS from the ECS (301). The EAS announcer (226) is further configured to transmit a declare common EAS request message to the at least one second EES; wherein the declare common EAS request message comprises the selected common EAS along with the grouping information. The EAS announcer (226) is further configured to receive a declare common EAS response message from the at least one second EES; wherein the declare common EAS response message comprises the acknowledgement.

The ECS (301) is connected to the first EEC (100) and the EES (150).

The EAS announcer (226) is configured to determine whether the common EAS is already selected for the multi-user or the multi AC session based on the grouping information. The EAS announcer (226) is further configured to transmit the already selected common EAS to the first EEC (100) to initiate the multi-user or the multi AC session when the common EAS is already selected for the multi-user or the multi AC session based on the grouping information. The EAS announcer (226) is further configured to select the plurality of EAS based on the grouping information when the common EAS is not already selected for the multi-user or the multi AC session based on the grouping information; and sending the plurality of EAS to the first EEC (100).

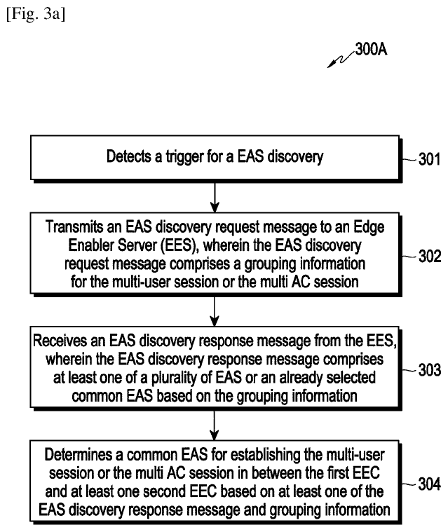

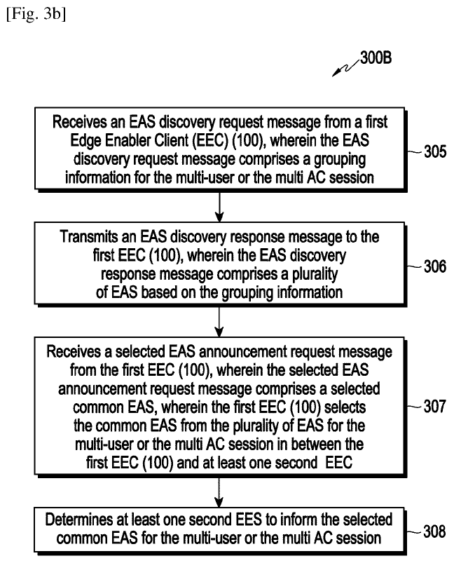

FIG. 3a is a flow chart (300A) illustrating a method of discovering the common EAS by the first EEC (100), according to the embodiments as disclosed herein.

At step 301, the first EEC (100) detects a trigger for an EAS discovery.

At step 302, the first EEC (100) transmits an EAS discovery request message to the EES, wherein the EAS discovery request message comprises a grouping information for the multi-user session or the multi AC session.

At step 303, the first EEC (100) receives a EAS discovery response message from the EES, wherein the EAS discovery response message comprises at least one of a plurality of EAS or an already selected common EAS based on the grouping information

At step 304, the first EEC (100) determines a common EAS for establishing the multi-user session or the multi AC session in between the first EEC (100) and at least one second EEC based on at least one of the EAS discovery response message and grouping information

The various actions, acts, blocks, steps, or the like in the flow diagram (200) may be performed in the order presented, in a different order or simultaneously. Further, in some embodiments, some of the actions, acts, blocks, steps, or the like may be omitted, added, modified, skipped, or the like without departing from the scope of the invention.

FIG. 3b is a flow chart (300B) illustrating a method of discovering the common EAS by the EES, according to the embodiments as disclosed herein.

At step 305, the EES receives an EAS discovery request message from a first Edge Enabler Client (EEC) (100), wherein the EAS discovery request message comprises a grouping information for the multi-user or the multi AC session.

At step 306, the EES transmits an EAS discovery response message to the first EEC (100), wherein the EAS discovery response message comprises a plurality of EAS based on the grouping information.

At step 307, the EES receives a selected EAS announcement request message from the first EEC (100), wherein the selected EAS announcement request message comprises a selected common EAS, wherein the first EEC (100) selects the common EAS from the plurality of EAS for the multi-user or the multi AC session in between the first EEC (100) and at least one second EEC.

At step 308, the EES determines at least one second EES to inform the selected common EAS for the multi-user or the multi AC session.

The various actions, acts, blocks, steps, or the like in the flow diagram (200) may be performed in the order presented, in a different order or simultaneously. Further, in some embodiments, some of the actions, acts, blocks, steps, or the like may be omitted, added, modified, skipped, or the like without departing from the scope of the invention.

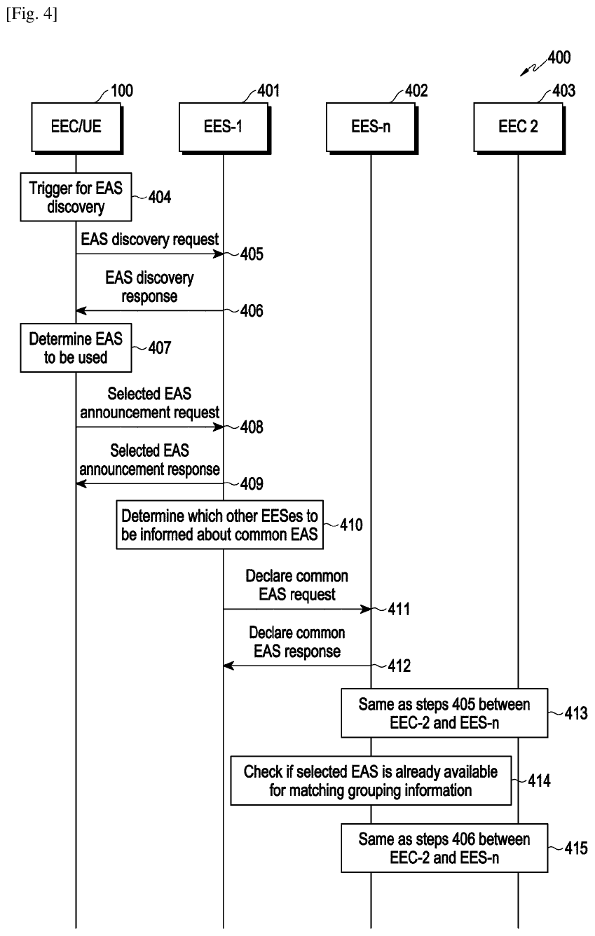

FIG. 4 is a sequence diagram illustrating the EEC based EAS discovery procedure for common EAS selection, according to the embodiments as disclosed herein.

Following enhancements to an AC profile including grouping information is proposed in the proposed invention in addition to the AC Profile defined in the prior arts.

TABLE 1
<(AC Profile - enhanced)>

| Information | | |
|---|---|---|
| element | Status | Description |
| Grouping | O | Indicates Grouping is required for |
| required | | the application. |
| > multi-user | O | Indicates application requires |
| session (NOTE | | multi-user session |
| 1) | | |
| > multi-AC | O | Indicates multiple Acs would be |
| session (NOTE | | part of the session |
| 1) | | |
| >> List of ACIDs | O | Indicates one or more ACIDs to |
| (NOTE 2) | | be part of the session |

(NOTE 1):
Either one of these or both are present depending on the application scenario.
(NOTE 2):
At least one ACID is mandatory when multi-AC session IE is present.

The procedure supports selection of the common EAS is provided below and the procedure is same for all the figures of the proposed invention—
for the same ACID on UEs of different Users (aware or unaware of each other), within the same EDN
for group of ACIDs on UEs of same User within the same EDN
per group within the same EDN and for the same ACID(s)
for new UEs requesting to join after a common EAS is already selected
re-selection of a common EAS to maintain similar service experience among the users (aware or unaware of each other) requesting same ACID e.g. whenever new UEs are added or removed to/from the session, due to mobility, unavailability of EAS
handling race conditions e.g. EAS discovery before common EAS announcement is made to EES.
a user can be connected to multiple EDNs at the time, and at one location there can be multiple EDNs available

Pre-conditions are provided below and the Pre-conditions is same for all the figures of the proposed invention:
AC Profile is enhanced with Grouping required information that tells whether the AC requires a multi-user session or multi-AC session etc.
EAS registers to EES according to clause 8.4.3 EAS Registration in TS 23.558.
EEC-1 is registered to EES-1 and EEC-2 is registered to EES-n.
EEC-1 may receive list of EESes from ECS relevant to the group-ID.

At step 404, the EEC detects the trigger for EAS discovery.

At step 405, the EEC transmits the EAS discovery request message to the EES,
wherein the EAS discovery request message comprises the grouping information for the multi-user session or the multi AC session.

At step 406, the EEC receives the EAS discovery response message from the EES, EES-1 considers grouping information as one of the discovery filters to decide the list of EASes to return in the response to EEC-1's EAS discovery request. Grouping information can be the multi-user session or multi-AC session or a combination of both. The EES-1 checks if there is already the selected EAS corresponding to the received Grouping required information from EEC-1. If it exists then the EES returns the selected EAS. Otherwise, the EES determines the list of EAS.

At step 407, the EEC determines the common EAS for establishing the multi-user session or the multi AC session in between the first EEC (100) and at least one second EEC based on at least one of the EAS discovery response message and grouping information. Further in an embodiment, the common EAS is selected from the list of EAS.

At step 408, the EEC transmits the selected EAS announcement request message to the EES, wherein the selected EAS announcement request message comprises the selected common EAS and the grouping information to the EES; and

At step 409, the EEC receives the selected EAS announcement response message from the EES, wherein the selected EAS announcement response message comprises the acknowledgement.

At step 410, the first EES (150) determines at least one second EES to inform the selected common EAS for the multi-user or the multi AC session.

The step 410, further comprises the Selected EES-1 contacts ECS (301) along with EASID information of the Selected EAS to determine which other EES(s) serve the same EASID. Otherwise, EES-1 (150) uses the list of other EESes as received in the previous step. The ECS (301) provides endpoint information of other EES(s) corresponding to the requested EASID information.

At step 411, the first EES (150) transmits the declare common EAS request message to the at least one second EES; wherein the declare common EAS request message comprises the selected common EAS along with the grouping information.

At step 412, the first EES (150) receives the declare common EAS response message from the at least one second EES; wherein the declare common EAS response message comprises the acknowledgement.

At step 413, when EEC-2 access the EES-n, the steps 405 will be performed between EEC-2 and EES-n.

At step 414, the EES-n check if selected EAS is already available for matching grouping information.

At step 415, the first EES-n will perform the step 406 with the EEC-2. The EDN configuration information received from ECS (301) may then be used by EEC-1 and EEC-2 for establishing a connection to the common EAS.

The various actions, acts, blocks, steps, or the like in the flow diagram (200) may be performed in the order presented, in a different order or simultaneously. Further, in some embodiments, some of the actions, acts, blocks, steps, or the like may be omitted, added, modified, skipped, or the like without departing from the scope of the invention.

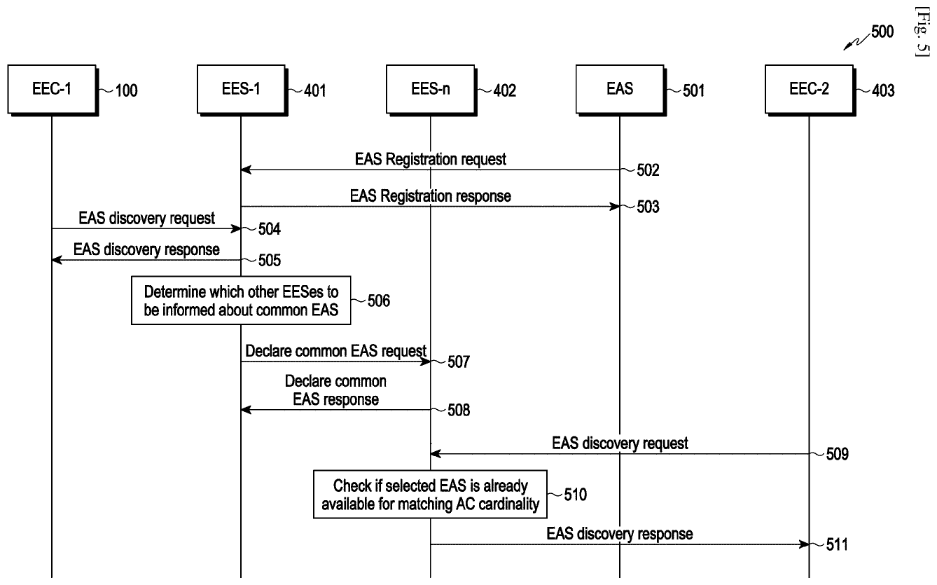

FIG. 5 is a sequence diagram illustrating the EEC based EAS Discovery procedure and the involvement of EAS, according to the embodiments as disclosed herein.

At step 502, the EAS sends an EAS registration request to the EES-1. The request shall include the enhanced EAS profile, including the grouping information as described in Table-1.

At step 503, upon successful authorization, the EES-1 stores the EAS Profile for later use (e.g. for serving EAS discovery requests received from EECs, etc.) and replies to the EAS with an EAS registration response.

At step 504, the EES-1 considers grouping information from the registered EASs as one of the discovery filters to decide the list of EASes to return in the response to EEC-1's EAS discovery request. Grouping information can be a multi-user session or multi-AC session or a combination of both. The EES-1 checks, based on the grouping information from the registered EASs and the AC profile information from the EEC-1's discovery request, if there is already a selected EAS corresponding to the Grouping required information and the AC profile information from the EEC-1. If it exists then the EES returns the selected EAS. Otherwise, the EES determines the list of EAS.

At step 505, the EES responds to the EEC-1 with the selected common EAS information in EAS discovery response message.

At step 506, the EES-1 determines which other EESes to be informed about the selected EAS e.g. serving the same AC within the EDN.

At step 507, Selected EES-1 then declares common EAS selection to all the determined EESes (EES-n).

At step 508, EES-n stores the received common EAS information along with the Grouping required information and sends back an acknowledgement to EES-1.

At step 509, Similar to step 503, EES-n receives EAS discovery request from EEC-2.

At step 510, the EES-n checks if there is already a selected EAS corresponding to the AC profile information in the EAS discovery request message from EEC-2.

At step 511, when a common EAS is available, EES-n then informs the common EAS information to the EEC-2.

In an embodiment, Steps 508 to 510 from FIG. 5 can be performed by EEC-1 instead of EES-1. The EDN configuration information received from ECS (301) may then be used by EEC-1 and EEC-2 for establishing a connection to the common EAS.

The various actions, acts, blocks, steps, or the like in the flow diagram (200) may be performed in the order presented, in a different order or simultaneously. Further, in some embodiments, some of the actions, acts, blocks, steps, or the like may be omitted, added, modified, skipped, or the like without departing from the scope of the invention.

In an embodiment, EEC-1 and EEC-2 of multi-user sessions can belong to the same ECSP or different ECSP, for discovering common EAS for EEC (100) located within the same service provider domain or different service provider domain. When ECS-2 belongs to a different ECSP, EEC-2 may receive configuration information of EDN of other ECSP based on the service level agreement between the two services providers (i.e. via federation).

In an embodiment, EES-1 and EEN-n may be within the same EDN or different EDN, for discovering common EAS for EEC (100) located in the same EDN or different EDN. When ECS-2 belongs to another EDN, EEC-2 may receive configuration information of the other EDN from the common ECS.

In an embodiment, ACs of multi-AC sessions may be within the same UE or different UE, for discovering common EAS for EEC (100) located in the same EDN or different EDN. When ACs are located on the same UE, EEC informs the already selected common EAS to the other AC involved in multi-AC session (UE internal communication i.e. over EDGE-5). When ACs are located on the different UE, EEC informs the selected common EAS to the other AC located on another UE as described in FIG. 5.

In an embodiment, when the use of service from a common EAS with service continuity support is expected, Steps 504 to 508 are repeated to select a new common EAS.

In an embodiment, the attributes multi-user session and multi-AC session are part of the AC Type attribute of the AC profile, or independent attributes.

The embodiments disclosed herein can be implemented using at least one hardware device and performing network management functions to control the elements

In an embodiment, the procedure supports selection of a common EAS is for the same ACID on UEs of different Users (aware or unaware of each other), within the same EDN or for group of ACIDs on UEs of same User within the same EDN or per group within the same EDN and for the same ACID(s) or for new UEs requesting to join after a common EAS is already selected or re-selection of a common EAS to maintain similar service experience among the users (aware or unaware of each other) requesting same ACID e.g. whenever new UEs are added or removed to/from the session, due to mobility, unavailability of EAS. Handling race conditions e.g. EAS discovery before common EAS announcement is made to EES or user can be connected to multiple EDNs at the time, and at one location there can be multiple EDNs available.

In an embodiment, the EES-1 determines which other EESes to be informed about the selected EAS e.g. serving the same AC within the EDN as per the procedure in clause 8.8.3.3 of TS 23.558 for the EES-1 to retrieve the EES-n information from the ECS. The Selected EES-1 contacts ECS (301) along with EASID information of the Selected EAS to determine which other EES(s) serve the same EASID. The ECS (301) provides endpoint information of other EES(s) as described in table, corresponding to the requested EASID information.

In an embodiment, the EDN configuration information received from ECS-1 may then be used by EEC-1 and EEC-2 for establishing a connection to the common EAS. If KPIs are not met for EEC (100) connected to common EAS (e.g. whenever new UEs are added or removed to/from the session, due to mobility, unavailability of EAS) then ACR procedures shall be used re-select a new common EAS to ensure equivalent KPIs for those EECs. To handle any race conditions, ACR procedures shall be used re-select a new common EAS to ensure equivalent KPIs for those EECs.

In an embodiment, Steps 413 to 415 from FIG. 4 can be performed by EEC-1 instead of EES-1.

In an embodiment, EEC-1 and EEC-2 of multi-user session can belong to same ECSP or different ECSP, for discovering common EAS for EEC (100) located within same service provider domain or different service provider domain. When ECS-2 belongs to different ECSP, EEC-2 may receive configuration information of EDN of other ECSP based on the service level agreement between the two services providers (i.e. via federation).

In an embodiment, EES-1 and EEN-n may be within same EDN or different EDN, for discovering common EAS for EEC (100) located in same EDN or different EDN. When ECS-2 belongs to another EDN, EEC-2 may receive configuration information of the other EDN from common ECS.

In an embodiment, ACs of multi-AC session may be within same UE or different UE, for discovering common EAS for EEC (100) located in same EDN or different EDN. When ACs are located on the same UE, EEC informs the already selected common EAS to the other AC involved in multi-AC session (UE internal communication i.e. over EDGE-5). When ACs are located on the different UE, EEC informs the selected common EAS to the other AC located on another UE as described in FIG. 2 via EEC (100) and EES.

In an embodiment, when use of service from a common EAS with service continuity support is expected, Steps 2 to 6 are repeated to select a new common EAS.

In an embodiment, the attributes multi-user session and multi-AC session are part of AC Type attribute of the AC profile, or independent attributes.

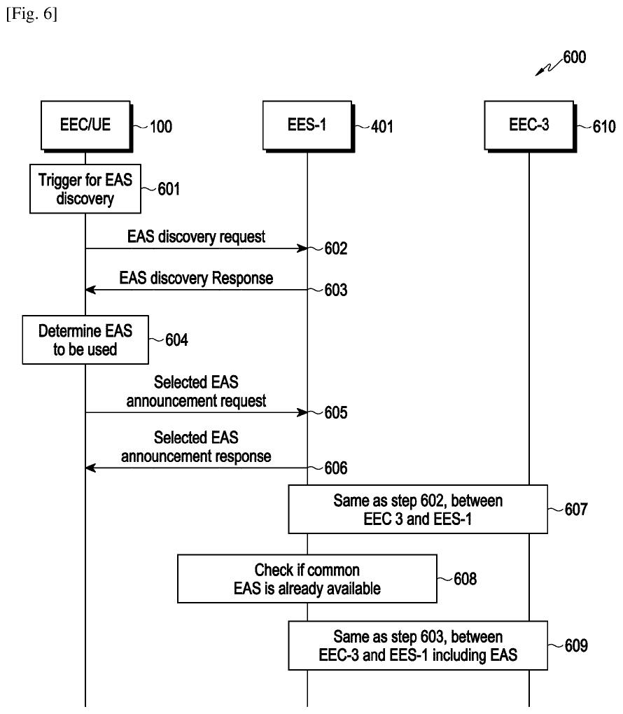

FIG. 6 is a sequence diagram illustrating the discovery of the common EAS when plurality of EEC(s) are connected to same EES, according to the embodiments as disclosed herein.

At step 601, the EEC detects the trigger for EAS discovery.

At step 602, the EEC transmits the EAS discovery request message to the EES-1, wherein the EAS discovery request message comprises the grouping information for the multi-user session or the multi AC session.

At step 603, the EEC receives the EAS discovery response message from the EES-1, EES-1 considers grouping information as one of the discovery filters to decide the list of EASes to return in the response to EEC-1's EAS discovery request. Grouping information can be the multi-user session or multi-AC session or a combination of both. The EES-1 checks if there is already the selected EAS corresponding to the received Grouping required information from EEC-1. If it exists then the EES returns the selected EAS. Otherwise, the EES determines the list of EAS.

At step 604, the EEC determines the common EAS for establishing the multi-user session or the multi AC session in between the first EEC (100) and EEC-3 based on at least one of the EAS discovery response message and grouping information. Further in an embodiment, the common EAS is selected from the list of EAS.

At step 605, the EEC transmits the selected EAS announcement request message to the EES-1, wherein the selected EAS announcement request message comprises the selected common EAS and the grouping information to the EES-1.

At step 606, the EEC receives the selected EAS announcement response message from the EES, wherein the selected EAS announcement response message comprises the acknowledgement.

At step 607, Similar to step 602, EES-n receives EAS discovery request from EEC-3.

At step 608, the EES-1 checks if there is already a selected EAS corresponding to the AC profile information in the EAS discovery request message from EEC-3.

At step 609, when a common EAS is available, EES-1 then informs the common EAS information to the EEC-3. The EDN configuration information received from ECS may then be used by EEC-1 and EEC-3 for establishing a connection to the common EAS.

The various actions, acts, blocks, steps, or the like in the flow diagram (200) may be performed in the order presented, in a different order or simultaneously. Further, in some embodiments, some of the actions, acts, blocks, steps, or the like may be omitted, added, modified, skipped, or the like without departing from the scope of the invention.

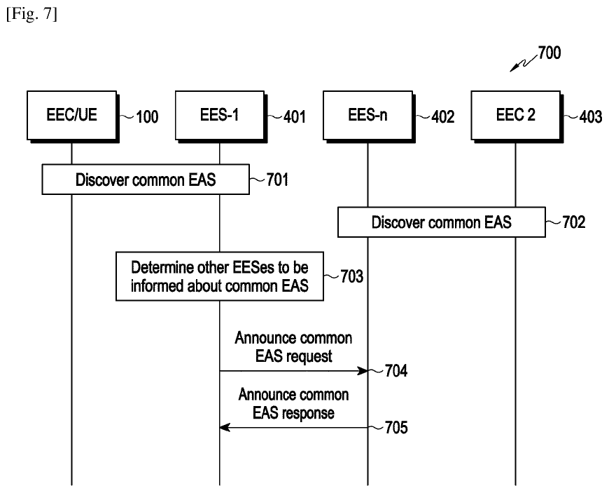

FIG. 7 is a sequence diagram illustrating the discovery of the common EAS when plurality of EEC(s) are connected to different EES, according to the embodiments as disclosed herein.

At step 701 and 702, the EEC and EEC-2 performs the common EAS discovery procedure.

At step 703, the EES-1 determines which other EESes to be informed about the selected common EAS e.g. serving the same EASID within the EDN for the EES to retrieve the other EES information from the ECS. The EES contacts ECS (301) along with EASID information of the selected common EAS to determine which other EES(s) serve the same EASID. The ECS (301) provides endpoint information of other EES(s) as described in table 8.3.3.3.3-2 of 3GPP TS 23.558, corresponding to the requested EASID information.

At step 704, EES-1 then declares selected common EAS to all the determined EES(s) along with the Grouping required information and Group ID (if present).

At step 705, Receiving EES stores the received selected common EAS information along with the Grouping required information and Group ID (if present) and sends back an acknowledgement to the sending EES by the EEC-2. The EES(s) receiving the selected common EAS information which is different from the one it has selected a common EAS, EASs are notified about the other common EASs via EDGE-3 noti-fications. EASs may initiate EAS-EAS sync as decided and supported by the application and the details of the same are implementation specific.

The various actions, acts, blocks, steps, or the like in the flow diagram (200) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within scope of the embodiments as described herein.

According to an embodiment, a method of discovering a common Edge Application Server (EAS) for a multi-user or a multi-Application Client (AC) session in a wireless communication network is provided. The method comprises: detecting, by a first Edge Enabler Client (EEC) (100), a trigger for an EAS discovery; transmitting, by the first EEC (100), an EAS discovery request message to an Edge Enabler Server (EES) (150), wherein the EAS discovery request message comprises a grouping information for the multi-user session or the multi AC session; receiving, by the first EEC (100), an EAS discovery response message from the EES, wherein the EAS discovery response message comprises at least one of a plurality of EAS or an already selected common EAS based on the grouping information; and determining, by the first EEC (100), a common EAS for establishing the multi-user session or the multi AC session in between the first EEC (100) and at least one second EEC based on at least one of the EAS discovery response message and grouping information.

According to an embodiment, the method comprises: transmitting, by the first EEC (100), a selected EAS announcement request message to the EES, wherein the selected EAS announcement request message comprises the selected common EAS and the grouping information to the EES; and receiving, by the first EEC (100), a selected EAS announcement response message from the EES, wherein the selected EAS announcement response message comprises the acknowledgement.

According to an embodiment, the grouping information comprises: a grouping requirement IE indicating grouping is required for the application; a multi-user session IE indicating application requires multi-user session; a multi-AC session IE indicating multiple ACs is part of the session; a group ID IE indicating the ID for grouping of users of same AC or grouping of ACs; and a List of ACIDs IE indicating one or more ACIDs need to be served by the common EAS, to be part of the multi-user session.

According to an embodiment, the selected EAS announcement request message comprises the AC ID, an EAS ID, an EAS endpoint, and an User Equipment ID.

According to an embodiment, a method of discovering a common Edge Application Server (EAS) for a multi-user or a multi-Application Client (AC) session in a wireless communication network is provided. The method comprises: receiving, by the first Edge Enabler Server (EES) (150), a EAS discovery request message from a first Edge Enabler Client (EEC) (100), wherein the EAS discovery request message comprises a grouping information for the multi-user or the multi AC session; transmitting, by the first EES (150), a EAS discovery response message to the first EEC (100), wherein the EAS discovery response message comprises a plurality of EAS based on the grouping information; receiving, by the first EES (150), a selected EAS announcement request message from the first EEC (100), wherein the selected EAS announcement request message comprises a selected common EAS, wherein the first EEC (100) selects the common EAS from the plurality of EAS for the multi-user or the multi AC session in between the first EEC (100) and at least one second EEC; determining, by the first EES (150), at least one second EES to inform the selected common EAS for the multi-user or the multi AC session.

According to an embodiment, determining, by the first EES (150), at least one second EES to inform the selected common EAS for the multi-user or the multi AC session comprises: transmitting, by the first EES (150), an Identifier (ID) of the selected common EAS to the Edge Configuration Server (ECS), wherein the ECS (301) determines the at least one second EES that serve the same ID of the selected common EAS; receiving, by the first EES (150), an Identifier of the at least one second EES that have the same ID of the selected common EAS from the ECS; transmitting, by the first EES (150), a declare common EAS request message to the at least one second EES; wherein the declare common EAS request message comprises the selected common EAS along with the grouping information; and receiving, by the first EES (150), a declare common EAS response message from the at least one second EES; wherein the declare common EAS response message comprises the acknowledgement.

According to an embodiment, receiving, by the first EES (150), the EAS discovery request message from the first EEC (100) comprises: determining, by the first EES (150), whether the common EAS is already selected for the multi-user or the multi AC session based on the grouping information; performing, by the first EES (150), one of: transmitting, by the EES, the already selected common EAS to the first EEC (100) to initiate the multi-user or the multi AC session when the common EAS is already selected for the multi-user or the multi AC session based on the grouping information; or selecting, by the EES, the plurality of EAS based on the grouping information when the common EAS is not already selected for the multi-user or the multi AC session based on the grouping information; and sending the plurality of EAS to the first EEC (100).

According to an embodiment, the grouping information comprises: a grouping requirement IE indicating grouping is required for the application; a multi-user session IE indicating application requires multi-user session; a multi-AC session IE indicating multiple ACs is part of the session; a group ID IE indicating the ID for grouping of users of same AC or grouping of ACs; and a List of ACIDs IE indicating one or more ACIDs need to be served by the common EAS, to be part of the multi-user session.

According to an embodiment, the selected EAS announcement request message comprises the AC ID, an EAS ID, an EAS endpoint, and an User Equipment ID.

According to an embodiment, a first Edge Enabler Client (EEC) (100) for discovering a common Edge Application Server (EAS) for a multi-user or a multi-Application Client (AC) session in a wireless communication network is provided. The first EEC comprises: a memory (211); a processor (213); EAS discoverer (216), coupled to the memory (211) and the processor (213), configured to: detect a trigger for an EAS discovery; transmit an EAS discovery request message to an Edge Enabler Server (EES) (150), wherein the EAS discovery request message comprises a grouping information for the multi-user session or the multi AC session; receive an EAS discovery response message from the EES, wherein the EAS discovery response message comprises at least one of a plurality of EAS or an already selected common EAS based on the grouping information; and determine a common EAS for establishing the multi-user session or the multi AC session in between the first EEC (100) and at least one second EEC based on at least one of the EAS discovery response message and grouping information.

According to an embodiment, the EAS discoverer (216) is configured to: transmit a selected EAS announcement request message to the EES, wherein the selected EAS announcement request message comprises the selected common EAS and the grouping information to the EES; and receive a selected EAS announcement response message from the EES, wherein the selected EAS announcement response message comprises the acknowledgement.

According to an embodiment, the grouping information comprises: a grouping requirement IE indicating grouping is required for the application; a multi-user session IE indicating application requires multi-user session; a multi-AC session IE indicating multiple ACs is part of the session; a group ID IE indicating the ID for grouping of users of same AC or grouping of ACs; and a List of ACIDs IE indicating one or more ACIDs need to be served by the common EAS, to be part of the multi-user session.

According to an embodiment, the selected EAS announcement request message comprises the AC ID, an EAS ID, an EAS endpoint, and an User Equipment ID.

According to an embodiment, a first Edge Enabler Server (EES) (150) for discovering a common Edge Application Server (EAS) for a multi-user or a multi-Application Client (AC) session in a wireless communication network is provide. The first EES comprises: a memory (221); a processor (223); EAS announcer (226), coupled to the memory (221) and the processor (223), configured to: receive an EAS discovery request message from a first Edge Enabler Client (EEC) (100), wherein the EAS discovery request message comprises a grouping information for the multi-user or the multi AC session; transmit an EAS discovery response message to the first EEC (100), wherein the EAS discovery response message comprises a plurality of EAS based on the grouping information; receive a selected EAS announcement request message from the first EEC (100), wherein the selected EAS announcement request message comprises a selected common EAS, wherein the first EEC (100) selects the common EAS from the plurality of EAS for the multi-user or the multi AC session in between the first EEC (100) and at least one second EEC; determine at least one second EES to inform the selected common EAS for the multi-user or the multi AC session.

According to an embodiment, determines at least one second EES to inform the selected common EAS for the multi-user or the multi AC session, comprises: transmit an Identifier (ID) of the selected common EAS to the Edge Configuration Server (ECS), wherein the ECS (301) determines the at least one second EES that serve the same ID of the selected common EAS; receive an Identifier of the at least one second EES that have the same ID of the selected common EAS from the ECS; transmit a declare common EAS request message to the at least one second EES; wherein the declare common EAS request message comprises the selected common EAS along with the grouping information; and receive a declare common EAS response message from the at least one second EES; wherein the declare common EAS response message comprises the acknowledgement.

According to an embodiment, receives the EAS discovery request message from the first EEC (100) comprises: determine whether the common EAS is already selected for the multi-user or the multi AC session based on the grouping information; perform one of: transmit the already selected common EAS to the first EEC (100) to initiate the multi-user or the multi AC session when the common EAS is already selected for the multi-user or the multi AC session based on the grouping information; or select the plurality of EAS based on the grouping information when the common EAS is not already selected for the multi-user or the multi AC session based on the grouping information; and sending the plurality of EAS to the first EEC (100).

According to an embodiment, wherein the grouping information comprises: a grouping requirement IE indicating grouping is required for the application; a multi-user session IE indicating application requires multi-user session; a multi-AC session IE indicating multiple ACs is part of the session; a group ID IE indicating the ID for grouping of users of same AC or grouping of ACs; and a List of ACIDs IE indicating one or more ACIDs need to be served by the common EAS, to be part of the multi-user session.

According to an embodiment, wherein the selected EAS announcement request message comprises the AC ID, an EAS ID, an EAS endpoint, and an User Equipment ID.

1-15. (canceled)

16. A method performed by a first edge enabler client (EEC) in a wireless communication network, the method comprising:
transmitting an edge application server (EAS) discovery request message to an edge enabler server (EES), wherein the EA S discovery request message includes grouping information;
receiving an EAS discovery response message from the EES, wherein the EAS discovery response message includes at least one EAS and information for the at least one EAS; and
selecting an EAS as a common EAS based on the at least one EAS received in the EAS discovery response message.

17. The method of claim 16, further comprising:
transmitting an EAS announcement request message to the EES, wherein the EAS announcement request message includes the common EAS and the grouping information; and
receiving an EAS announcement response message from the EES, wherein the EAS announcement response message includes an acknowledgement.

18. The method of claim 17, wherein the EAS announcement request message further includes at least one of an application client (AC) identifier (ID), an EAS ID, or an EAS endpoint.

19. The method of claim 16, wherein the grouping information comprises at least one of:
a grouping requirement information element (IE);
a group identifier (ID); and
a list of multi-application clients (ACs).

20. A method performed by a first Edge Enabler Server (EES) in a wireless communication network, the method comprising:
receiving an edge application server (EAS) discovery request message from a first edge enabler client (EEC), wherein the EAS discovery request message includes grouping information;
transmitting an EAS discovery response message to the first EEC, wherein the EAS discovery response message includes at least one EAS and information for the at least one EAS;
receiving an EAS announcement request message from the first EEC, wherein the EAS announcement request message includes a common EAS, wherein the first EEC selects the common EAS from the at least one EAS; and
determining at least one second EES to inform the common EAS.

21. The method of claim 20, wherein determining the at least one second EES to inform the common EAS comprises:
transmitting an identifier (ID) of the common EAS to an edge configuration server (ECS), wherein the ECS determines the at least one second EES that serves a same ID as the common EAS;
receiving, from the ECS, an ID of the at least one second EES that has the same ID as the common EAS;
transmitting a declare common EAS request message to the at least one second EES, wherein the declare common EAS request message includes the common EAS and the grouping information; and
receiving a declare common EAS response message from the at least one second EES, wherein the declare common EAS response message includes an acknowledgement.

22. The method of claim 20, wherein receiving the EAS discovery request message from the first EEC comprises:
determining whether the common EAS is already selected for a multi-user or a multi application client (AC) session based on the grouping information;
performing one of:
transmitting the common EAS to the first EEC to initiate the multi-user or the multi AC session when the common EAS is already selected for the multi-user or the multi AC session based on the grouping information; or
selecting a plurality of EAS based on the grouping information when the common EAS is not already selected for the multi-user or the multi AC session
based on the grouping information; and
sending the at least one EAS to the first EEC.

23. The method of claim 20, wherein the grouping information comprises at least one of:
a grouping requirement information element (IE);
a group identifier (ID); and
a list of application clients (ACs).

24. The method of claim 20, wherein the EAS announcement request message further includes at least one of an application client (AC) identifier (ID), an EAS ID, or an EAS endpoint.

25. A first edge enabler client (EEC) in a wireless communication network, the first EEC comprising:
a memory;
a processor;
an edge application server (EAS) discoverer, coupled to the memory and the processor, and configured to:
transmit an EAS discovery request message to an edge enabler server (EES), wherein the EAS discovery request message includes grouping information,
receive an EAS discovery response message from the EES, wherein the EAS discovery response message includes at least one EAS and information for the at least one EAS, and
select an EAS as a common EAS based on the at least one EAS received in the EAS discovery response message.
